(19) United States
(12) Patent Application Publication
(10) Pub. No.: US 2006/0140474 A1
(43) Pub. Date: Jun. 29, 2006

(54) Apparatus and method for generating analysis data, computer-readable recording medium in which analysis data generating program is stored, analysis apparatus, analyzing method and computer-readable recording medium in which analysis program is stored

(75) Inventor: Yasushi Uraki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/108,100

(22) Filed: Apr. 18, 2005

(30) Foreign Application Priority Data
Dec. 28, 2004 (JP) 2004-379485

(51) Int. Cl. G06K 9/00; G06K 9/60; G06K 9/54

(52) U.S. Cl. 382/154; 382/303; 382/304

(57) ABSTRACT

An apparatus for generating analysis data including: an analysis data generating section for generating analysis data by dividing three-dimensional design data representing an object having elements into a number of rectangular parallelepipeds for each element; a non-coincident portion extracting section for extracting, from the analysis data, a possible non-coincident portion formed by surfaces of two of the rectangular parallelepipeds included in said analysis data, the surfaces not coinciding with each other, the two rectangular parallelepipeds being corresponding one to each of two elements having surfaces coincide with each other in the three-dimensional design data; and an adjusting section for adjusting a shape of at least one of the two rectangular parallelepipeds in such a manner that said possible non-coincident portion is dissolved, so that it is possible to automatically and efficiently generate the analysis data in which gaps or the like are dissolved without operator's operation.

### BACKGROUND OF THE INVENTION

1. Field of the Invention

The present invention relates to a technology of generation of analysis data used for applying analysis to an object formed by a plurality of elements.

2. Description of the Related Art

Recently, a CAD (Computer Aided Design) system has been developpedin three-dimensional design for objects such as apparatuses. In order to efficiently use three-dimensional CAD data (hereinafter called three-dimensional design data) generated by means of CAD, efforts have been made in developing a tool for converting three-dimensional design data into shaping analysis data (hereinafter simply called analysis data), and various converting tools have been proposed (see Japanese Patent Application Laid-Open No. 2003-271684).

There have been proposed techniques of CAD data conversion to another format data for various purposes (see Japanese Patent Application Laid-Open No. 2000-231580 and No. HEI 5-89255).

Conventionally, the art has been converting three-dimensional design data representing an object formed by a number of elements into analysis data by approximating (simplifying) the design data concerning each of the elements into a number of rectangular parallelepipeds. According to such a manner, three-dimensional design data representing an element A shown in FIG. 14(a) is divided into a number (here six) of rectangular parallelepipeds A1-A6 as shown in FIG. 14(b), so that analysis data A′ for the element A is generated. Alternatively, as shown in FIG. 14(c), the element A is divided into detailed rectangular parallelepipeds a1-a12 (here 12 rectangular parallelepipeds) more than those in the analysis data A′ shown in FIG. 14(b). Thereby it is possible to generate analysis data a′ having higher accuracy than the analysis data A′ shown in FIG. 14(b).

In the above manner described with reference to FIGS. 14(a)-(c) in which analysis data is generated by dividing each of the elements into a number of rectangular parallelepipeds, three-dimensional design data representing an assembly (object) formed by a plurality of elements is converted into analysis data in which simplification for the conversion may cause gaps and/or interferences (overlaps) at portions corresponding to connections at which two of the elements coincide with each other.

For example, concerning an object in which a cylindrical element (a cap) D is inserted into the hole of a cylindrical element C shown in FIG. 15(a), three-dimensional data representing the object is divided into a plurality of rectangular parallelepipeds for each of the elements C and D, so that gaps S appear between the inner surface of the element C and the surface of the element D as shown in FIG. 15(b).

In other words, the inner surface of the element C and the surface of the element D coincide with each other at the connection in the three-dimensional design data as shown in FIG. 15(a) but rectangular parallelepipeds at the portion corresponding to the connection do not coincide with each other in the analysis data so that the gaps S are generated as shown in FIG. 15(b).

Since analysis data has such gaps and the like do not exist in original three-dimensional design data, an operator has manually dissolved each of the gaps and the like prior to analysis. In detail, the operator visually confirms a gap in analysis data displayed on a monitor; selects an edge of a rectangular parallelepiped that forms the gap using a mouse; drags a part of the rectangular parallelepiped using the mouse to vary the rectangular parallelepiped in length, width, and/or depth, or selects the rectangular parallelepiped and moves the rectangular parallelepiped to a suitable position using a mouse, so that the gap is dissolved. This entails a great deal of labor by the operator.

A great many objects formed by elements having curved surfaces generate gaps in analysis data, which gaps do not exist in original three-dimensional design data. In such cases, operators have to expend great time and effort, require a long time for dissolution of the gaps.

In addition, after operation to dissolve gaps and interferences, the operator have to visually check whether or not gaps and the interferences has actually been dissolved. This check also requires a great deal of effort the operator.

### SUMMARY OF THE INVENTION

With the foregoing problems in view, the object of the present invention is to generate analysis data that is to be used for analyzing an object formed by a plurality of elements in which data gaps and the like are automatically dissolved without an operation by an operator, so that the analysis data can be efficiently generated.

To attain the above object, as a first generic feature, there is provided an apparatus for generating analysis data comprising: an analysis data generating section for generating analysis data by dividing three-dimensional design data representing an object formed by a plurality of elements into a number of rectangular parallelepipeds for each of the plural elements; a non-coincident portion extracting section for extracting, from the analysis data, a possible non-coincident portion formed by surfaces of two of the rectangular parallelepipeds included in the analysis data generated by the analysis data generating section, the surfaces not coinciding with each other, the two rectangular parallelepipeds being corresponding one to each of two of the plural elements surfaces of which coincide with each other in the three-dimensional design data; and an adjusting section for adjusting a shape of at least one of the two rectangular parallelepipeds, which form the possible non-coincident portion extracted by the non-coincident portion extracting section, in such a manner that the possible non-coincident portion is dissolved, so that the analysis data is corrected.

As the second generic feature, there is provided a program for generating analysis data that is used for application of analysis to an object formed by a plurality of elements is recorded, wherein the program instructs a computer to function as: an analysis data generating section for generating analysis data by dividing three-dimensional design data representing the object into a number of rectangular parallelepipeds for each of the plural elements; a non-coincident portion extracting section for extracting, from the analysis data, a possible non-coincident portion formed by surfaces of two of the rectangular parallelepipeds included in the analysis data generated by the analysis data generating section, the surfaces not coinciding with each other, the two rectangular parallelepipeds being corresponding one to each of two of the plural elements surfaces of which coincide with each other in the three-dimensional design data; and an adjusting section for adjusting a shape of at least one of the two rectangular parallelepipeds, which form the possible non-coincident e portion extracted by the non-coincident portion extracting section, in such a manner that the possible non-coincident portion is dissolved, so that the analysis data is corrected.

As the third generic feature, there is provided a computer-readable recording medium in which the above program for generating analysis data is recorded.

As the fourth generic feature, there is provided a method for generating analysis data comprising the steps of: a) generating analysis data by dividing three-dimensional design data representing an object formed by a plurality of elements which design data is retained in a memory into a number of rectangular parallelepipeds for each of the plural elements; (b) extracting, from the analysis data, a possible non-coincident portion formed by surfaces of two of the rectangular parallelepipeds included in the analysis data generated in the step (a) of generating, the surfaces not coinciding with each other, the two rectangular parallelepipeds being corresponding one to each of two of the plural elements surfaces of which coincide with each other in the three-dimensional design data; and (c) adjusting a shape of at least one of the two rectangular parallelepipeds, which form the possible non-coincident portion extracted in the step (b) of extracting, in such a manner that the possible non-coincident portion is dissolved, so that the analysis data is corrected.

As a fifth generic feature, there is provided an analysis apparatus comprising: an analysis data generating section for generating analysis data by dividing three-dimensional design data representing an object formed by a plurality of elements into a number of rectangular parallelepipeds for each of the plural elements; a non-coincident portion extracting section for extracting, from the analysis data, a possible non-coincident portion formed by surfaces of two of the rectangular parallelepipeds included in the analysis data generated by the analysis data generating section, the surfaces not coinciding with each other, the two rectangular parallelepipeds being corresponding one to each of two of the plural elements surfaces of which coincide with each other in the three-dimensional design data; an adjusting section for adjusting a shape of at least one of the two rectangular parallelepipeds, which form the possible non-coincident portion extracted by the non-coincident portion extracting section, in such a manner that the possible non-coincident portion is dissolved, so that the analysis data is corrected; and an analyzing section for applying the object to analysis using the analysis data corrected by the adjusting section.

According to the present invention, it is possible to generate analysis data for analyzing an object formed by a plurality of elements in which data gaps and the like are automatically dissolved without an operation done by an operator, so that the analysis data can be efficiently generated.

Other objects and further features of the present invention will be apparent from the following detailed description when read in conjunction with the accompanying drawings.

### BRIEF DESCRIPTION OF THE DRAWINGS

FIG. 1 is a block diagram schematically showing an analysis apparatus according to a first embodiment of the present invention;

FIGS. 2(a) and 2(b) are diagrams illustrating analysis data generated by an analysis data generating section included in the analysis apparatus of FIG. 1, and more particularly, FIG. 2(a) illustrates three-dimensional design data simplified in two dimensions and FIG. 2(b) illustrates analysis data generated on the basis of the three-dimensional data shown in FIG. 2(a);

FIG. 3 is a diagram showing position data included in the analysis data of the analysis apparatus of FIG. 1;

FIGS. 4(a) and 4(b) are diagrams showing a manner for dissolving a non-coincident portion carried out by an adjusting section included in the analysis apparatus of FIG. 1, and more particularly, FIG. 4(a) illustrates analysis data having non-coincident portions and FIG. 4(b) illustrates analysis data in which the non-coincident portions shown in FIG. 4(a) have been dissolved;

FIG. 5 is a diagram showing dissolution of non-coincident portions included in analysis data shown in FIG. 2(b) by the adjusting section in the analysis apparatus of FIG.

FIG. 6 is a diagram showing position data included in analysis data of FIG. 5 in which non-coincident portions have been dissolved;

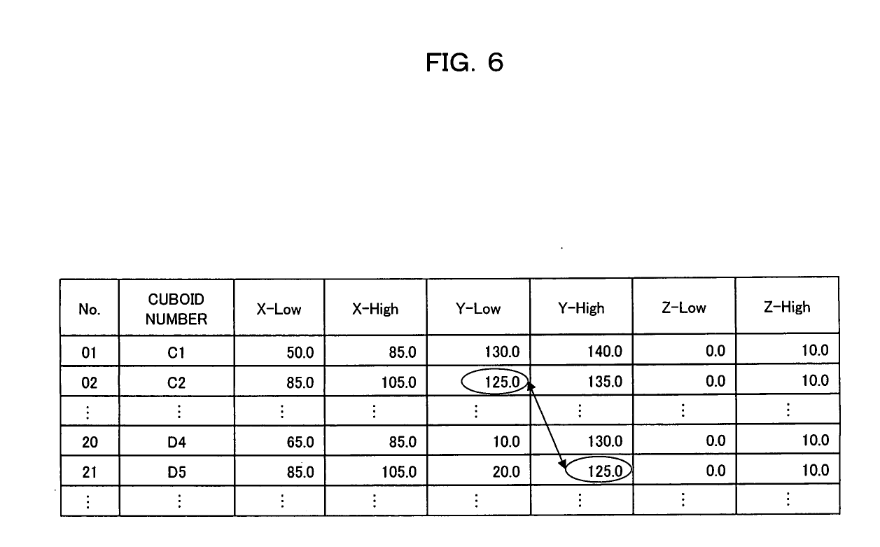

FIG. 7 is a diagram illustrating an example of a setting determining screen of a setting determining section of the analysis apparatus of FIG. 1;

FIGS. 8(a) and 8(b) are diagrams showing a manner of emphasizing a non-coincident portion by a display controlling section included in the analysis apparatus of FIG. 1, and more particularly FIG. 8(a) illustrates analysis data including a non-coincident portion and FIG. 8(b) illustrates the analysis data emphasizing the non-coincident portion shown in FIG. 8(a);

FIG. 9 is a flow diagram showing a succession of procedural steps of application of analysis to an object according to the first embodiment of the present invention;

FIGS. 10(a)-10(d) are diagrams illustrating a manner of extracting a non-coincident portion by a non-coincident portion extracting section included in the analysis apparatus of FIG. 1, and more particularly FIG. 10(a) illustrates analysis data having a non-coincident portion; FIG. 10(b), position data included in the analysis data shown in FIG. 10(a); FIG. 10(c), an internal process performed in the non-coincident portion extracting section; and FIG. 10(d), emphasis of the non-coincident portion in the analysis data of FIG. 10(a);

FIG. 11 is a block diagram schematically showing a modification of the analysis apparatus of the first embodiment;

FIG. 12 is a table illustrating coincident information obtained by a coincident information obtaining section of the analysis apparatus of FIG. 11;

FIGS. 13(a)-13(c) are diagrams showing another application of the coincident information obtaining section, the non-coincident portion extracting section, the adjusting section and the setting determining section of the analysis apparatus of the present invention, and more particularly, FIG. 13(a) illustrates CAD data; FIG. 13(b), CAD data in which a gap appears as a result of modification to the CAD data shown in FIG. 13(a); and FIG. 13(c), CAD data in which the gap shown in FIG. 13(b) has been dissolved;

FIGS. 14(a)-14(c) are diagrams illustrating analysis data used in the present invention, and more particularly FIG. 14(a) illustrates three-dimensional design data; FIGS. 14(b) and 14(c), analysis data created on the basis of the three-dimensional design data shown in FIG. 14(a); and

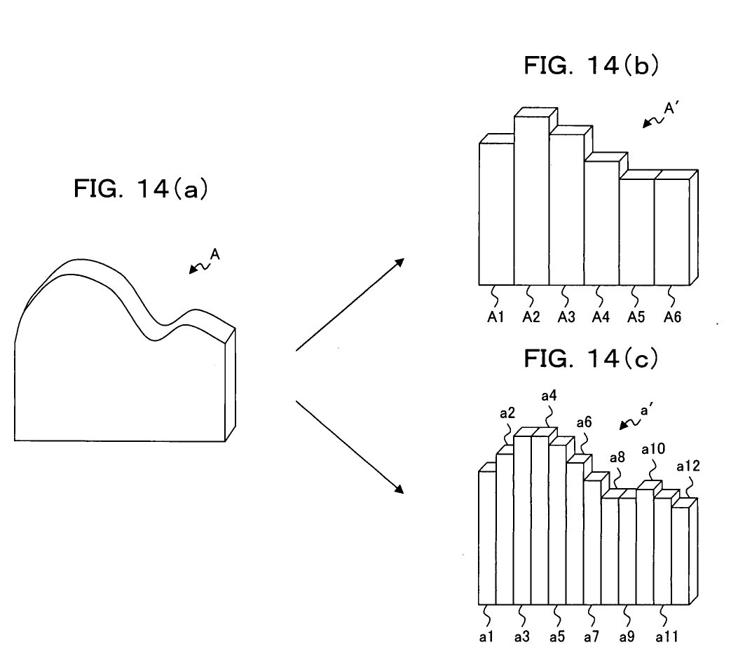

FIGS. 15(a) and 15(b) are diagrams illustrating analysis data and non-coincident portions (gaps) of the present invention, and more particularly, FIG. 15(a) illustrates three-dimensional data and FIG. 15(b) illustrates analysis data created on the basis of three-dimensional design data shown in FIG. 15(a).

### DESCRIPTION OF THE PREFERRED EMBODIMENTS

A preferred embodiment of the present invention will now be described with reference to the accompanying drawings.

### (1) First Embodiment

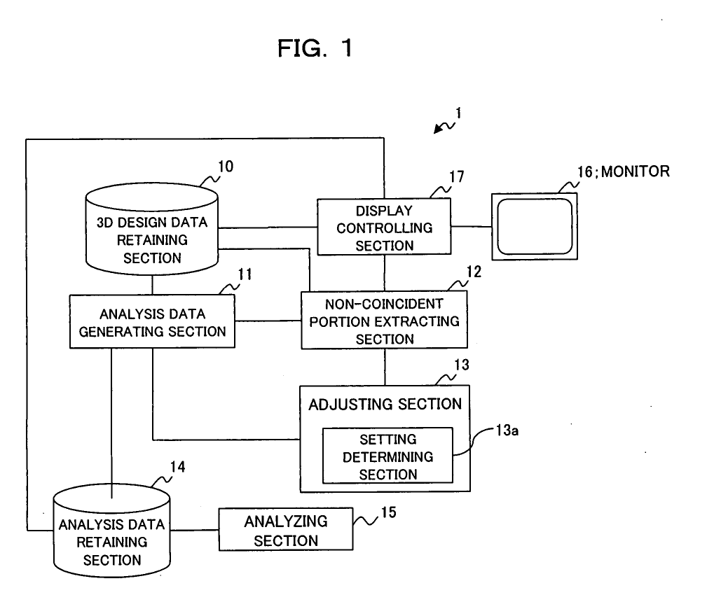

With reference to block diagram FIG. 1, an analysis apparatus 1 of the first embodiment will now be described. As shown in FIG. 1, the analysis apparatus 1 analyzes (simulates) deformation, stress and the like of an object formed by a plurality of elements, and includes a three-dimensional (hereinafter referred to as 3D) design retaining section 10, an analysis data generating section 11, a non-coincident portion extracting section 12, an adjusting section 13, an analysis data retaining section 14, an analyzing section 15, a monitor 16 and a display controlling section 17.

In the analysis apparatus 1, the 3D design data retaining section 10, the analysis data generating section 11, the non-coincident portion extracting section 12, the adjusting section 13, the analysis data retaining section 14, the monitor 16 and the display controlling section 17 unitedly function as an analysis data generating apparatus of the present invention.

Memories serving as the 3D design data retaining section 10 and the analysis data retaining section 14 are realized by a RAM (Random Access Memory) and a hard disk included in a personal computer that serves as the analysis apparatus 1.

The 3D design data retaining section 10 retains design data (CAD data) representing an object formed by uniting a number of elements which data is created by means of CAD (Computer Aided Design) and, here, more specifically retains design data (hereinafter called 3D design data) depicted in three dimensions.

The analysis data generating section 11 generates analysis data that is to be used for analysis (e.g., structural analysis) to be carried out in the analyzing section 15 by dividing 3D design data retained in the 3D design data retaining section 10 into a number of rectangular parallelepipeds for each of the elements. Throughout this embodiment, a rectangular parallelepiped is also referred to as a cuboid, and a rectangular parallelepiped in the description includes a cube of course.

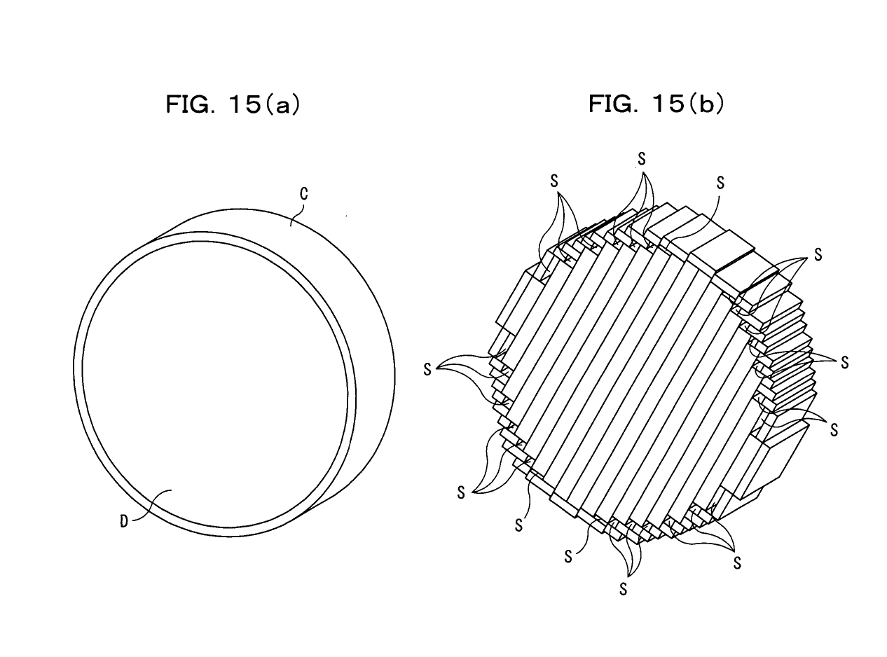

Specifically, as shown in FIGS. 15(a) and 15(b), each of elements C and D on the 3D design data shown in FIG. 15(a) is divided into a number of rectangular parallelepipeds and analysis data shown in FIG. 15(b) is thereby generated.

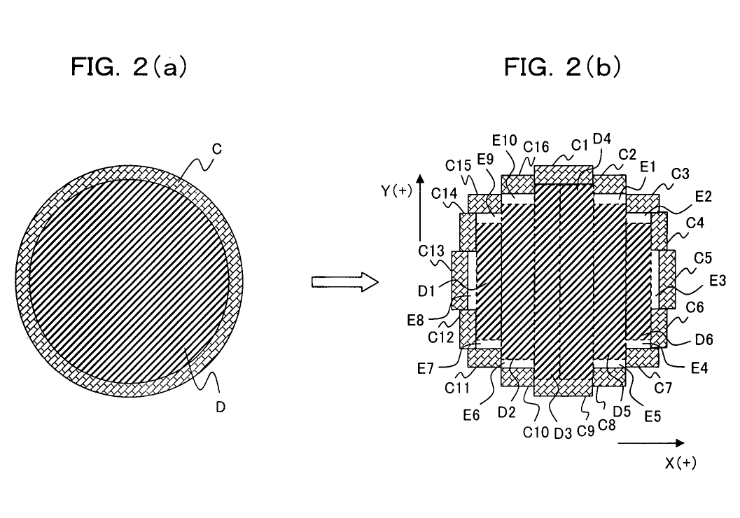

Here, two-dimensional expression of data shown in FIGS. 15(a) and 15(b) results in illustrations in FIGS. 2(a) and 2(b), respectively. FIGS. 15(a) and 15(b) correspond to FIGS. 2(a) and 2(b), respectively but data in FIG. 2(b) is simplified by showing fewer rectangular parallelepipeds than in the analysis data shown in FIG. 15(b).

As shown in FIGS. 2(a) and 2(b), the analysis data generating section 11 generates analysis data by dividing 3D design data representing an object formed by elements C and D shown in FIG. 2(a), for example, 16 rectangular parallelepipeds C1-C16 for the element C and 6 rectangular parallelepipeds D1-D6 for the element D as shown in FIG. 2(b).

When the analysis data generating section 11 generates analysis data, accuracy required for future analysis determines the number of rectangular parallelepipeds into which 3D design data concerning each element is divided. An analysis with high accuracy preferably divides each element into many detailed rectangular parallelepipeds. The analysis data generating section 11 is preferably able to generate analysis data in obedience to the number of rectangular parallelepipeds into which each element is divided and the sizes of the rectangular parallelepipeds which are determined by an operator who is to execute analysis.

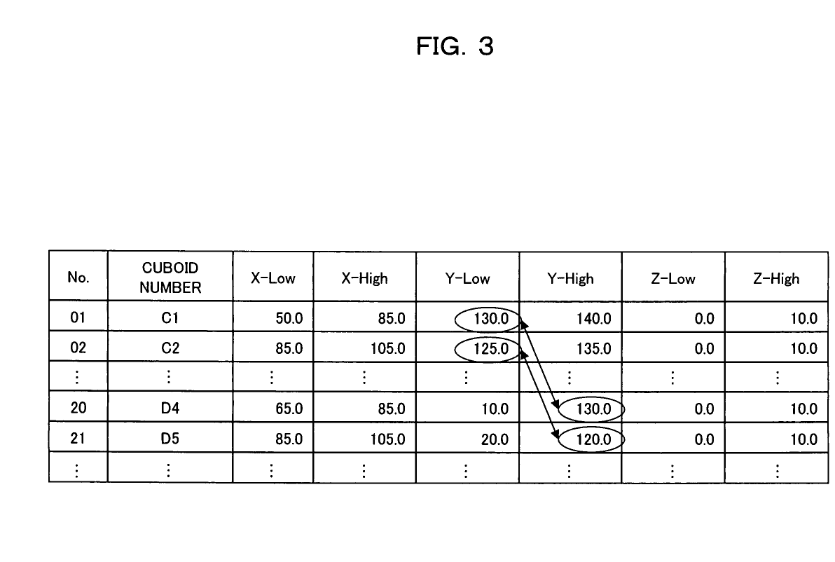

Analysis data generated by the analysis data generating section 11 includes position data shown in FIG. 3 concerning the position of each rectangular parallelepiped that forms analysis data, and more specifically the position data includes the position (X-Low, X-High, Y-Low, Y-High, Z-Low, and Z-High) of the vertexes (the surfaces) of each rectangular parallelepiped.

The non-coincident portion extracting section 12 extracts, from the analysis data generated by the analysis data generating section 11, a non-coincident portion formed by surfaces of two rectangular parallelepipeds which surfaces do not coincide with each other in the analysis data but corresponds to a connection at which two elements coincide with each other in the 3D design data but formed by two rectangular parallelepipeds corresponding one to each of the two elements surfaces of which do not coincide with each other in analysis data.

In other words, 3D design data representing an object having the elements C and D as shown in FIG. 2(a) is converted into analysis data shown in FIG. 2(b) by the analysis data generating section 11, and the elements C and D are represented by rectangular parallelepipeds formed by straight lines, so that the analysis data has non-coincident portions E1-E10 shown by white portions that are empty spaces (gaps) between surfaces of rectangular parallelepipeds.

According to shapes of elements, surfaces of two elements coincide with each other in the 3D design data but two rectangular parallelepipeds corresponding one to each of the two elements partially overlap to form a non-coincident portion (an interference portion) interposed between surfaces of the two rectangular parallelepipeds the surfaces of which do not coincide with each other in the analysis data generated by the analysis data generating section 11.

The non-coincident portion extracting section 12 extracts, from the analysis data, a possible non-coincident portion generated as a consequence of division of the 3D design data representing an object into a number of rectangular parallelepipeds for each of the elements in order to generate analysis data.

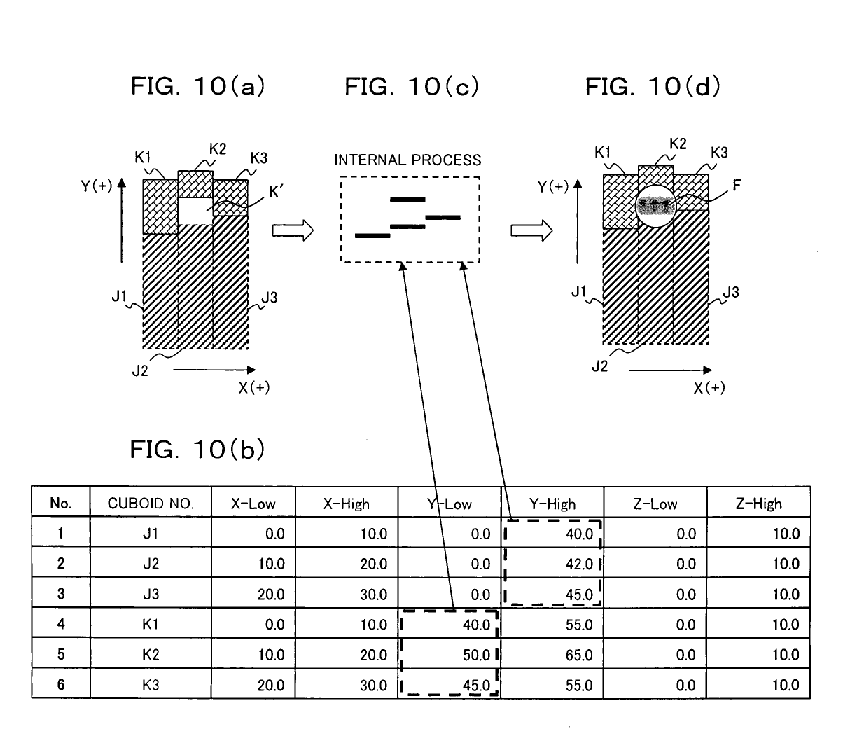

Specifically, the non-coincident portion extracting section 12 compares the analysis data with the 3D design data and extracts, from the analysis data, a non-coincident portion formed by rectangular parallelepipeds having surfaces that do not coincide with each other in the position data (see FIG. 3) while the corresponding portion of the surfaces of two elements, corresponding one to each of the surfaces of the rectangular parallelepipeds coincide with each other (see later-described FIGS. 10(a)-10(d)).

In order to dissolve a non-coincident portion by the adjusting section 13, the non-coincident portion extracting section 12 further has a function for confirming whether or not at least a part of the non-coincident portion is remaining in the analysis data in which at least one of the rectangular parallelepipeds that forms the non-coincident portion has been modified in shape and the modification has generated another non-coincident portion.

The adjusting section 13 adjusts the shape of at least one of the rectangular parallelepipeds that forms a non-coincident portion, which portion has been extracted by the non-coincident portion extracting section 12, so that the analysis data in which the non-coincident portion has been dissolved is generated.

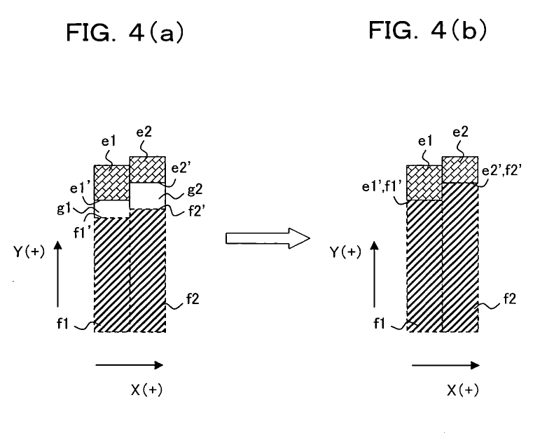

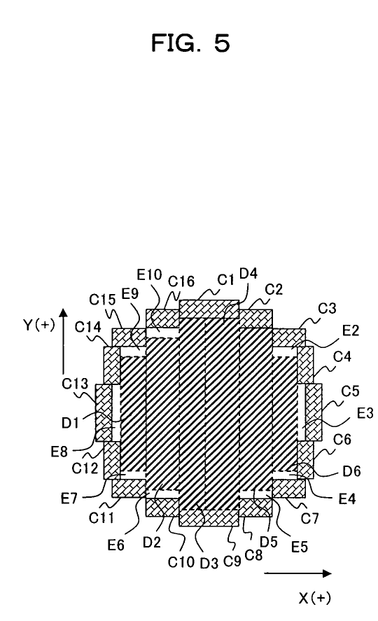

Here, FIGS. 4(a) and 4(b) show a manner for dissolving a non-coincident portion carried out by the adjusting section 13. FIGS. 4(a), 4(b) and later-described FIGS. 5, 8(a), 8(b), 10(a) and 10(b) illustrate 3D design data in two dimensions.

As shown in FIG. 4(a), for example, assuming that a non-coincident portion g1 is formed by rectangular parallelepipeds e1 and f1 in analysis data and a non-coincident portion g2 is formed by rectangular parallelepipeds e2 and f2 in the analysis data, the adjusting section 13 modifies a shape of either one (here, the rectangular parallelepipeds f1 and f2) of rectangular parallelepipeds that form each non-coincident portion as shown in FIG. 4(b) in order to dissolve the non-coincident portion. In other words, the adjusting section 13 does not simply move the rectangular parallelepipeds that form a non-coincident portion, but fixes the surface of one (master shape) of the rectangular parallelepipeds serving as a control and modifies the other rectangular parallelepiped (slave shape) in shape.

Here, in order to dissolve the non-coincident portion g1, the rectangular parallelepiped f1 is modified by being extended in the positive (+) direction of the Y axis in such a manner that surfaces e1′ and f1′ (represented by lines in two-dimensional illustrations FIGS. 4A(a) and 4(b)) of the rectangular parallelepipeds e1 and f1, which surfaces are opposite to each other and correspond to a part of a connection at which surfaces of two elements coincide with each other in the 3D design data, coincide with each other (i.e., positions of the surfaces e1′ and f1′ coincide with each other). In this case, the rectangular parallelepiped e1 is not modified in position nor in shape.

Further, in order to dissolve a non-coincident portion g2, in the same manner as that for dissolving the non-coincident portion g1, a rectangular parallelepiped f2 is extended in the positive (+) direction of the Y axis such that surfaces e2′ and f2′ of the rectangular parallelepipeds e2 and f2, which surfaces are opposite to each other, coincide with each other. Also in this case, the rectangular parallelepiped e2 is not modified in position nor in shape.

As described above, the non-coincident portion E1 shown in FIG. 2(b) is dissolved by extending a rectangular parallelepiped D5 in the positive direction of the Y axis as shown in FIG. 5, so that the Y-High coordinate of the rectangular parallelepiped D5 is changed to 125 as shown in FIG. 5, for example. Thereby, the Y-High coordinate of the rectangular parallelepiped D5 coincides with the Y-Low coordinate of a rectangular parallelepiped C2.

The adjusting section 13 preferably modifies the shape of a rectangular parallelepiped in a direction perpendicular to one of the surfaces of the rectangular parallelepiped, so that only a non-coincident portion that the operator wishes to dissolve can be definitely dissolved and high-speed processing can be realized.

In other words, if the adjusting section 13 modifies a rectangular parallelepiped without assigning direction and the rectangular parallelepiped is modified in a number of directions concurrently, the elements (the rectangular parallelepiped) are deformed beyond recognition of the original shape, and despite dissolution of a non-coincident portion, another problem such as the rectangular parallelepiped overlapping another element at a part where the element is not overlapped in the 3D design data will occur, which complicates dissolution of a non-coincident portion and requires extended processing time.

For this reason, the adjusting section 13 includes a setting determining section 13a that determines a rectangular parallelepiped the shape of which is to be modified and a direction of the modification when a non-coincident portion is to be dissolved. The operator determines a rectangular parallelepiped to be modified in shape and the modification direction by means of the setting determining section 13a. Upon determination of a rectangular parallelepiped to be modified and the modification direction by the setting determining section 13a, the adjusting section 13 dissolves anon-coincident portion on the basis of the determined settings.

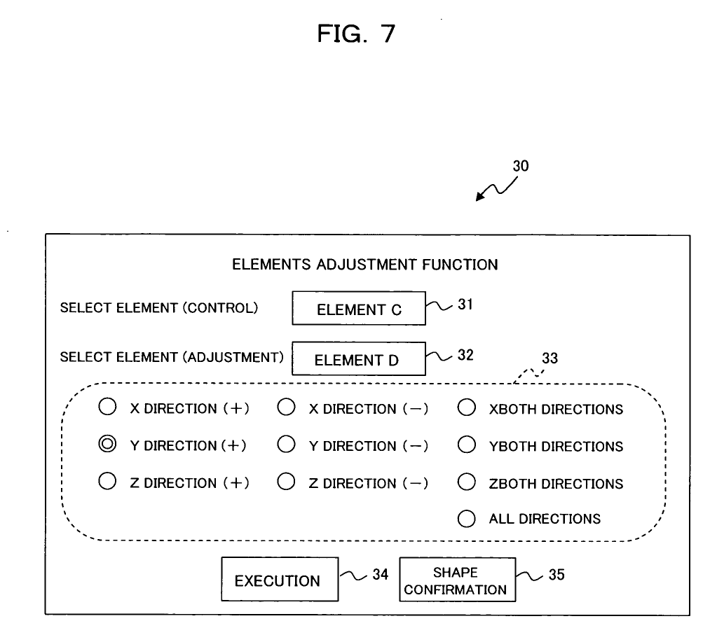

FIG. 7 illustrates an example of a setting determining screen of the setting determining section 13a. A setting determining screen of FIG. 7 is displayed on the monitor 16 by the display controlling section 17.

As shown in FIG. 7, a control element (master shape) is assigned on an assignation box 31 and the setting determining section 13a sets rectangular parallelepipeds corresponding to the assigned element as a reference (a control); and a target element that is to be modified in shape is assigned in an assignation box 32 and the setting determining section 13a sets rectangular parallelepipeds corresponding to the assigned element as a modification target (adjust). In addition, the modification direction in which elements (rectangular parallelepipeds) are to be modified is assigned in a setting field 33. After determining the above settings, click on an execution button 34 causes the adjusting section 13 to modify the assigned rectangular parallelepipeds in shape in the assigned direction, so that the non-coincident portions are dissolved. Alternatively, a click on a shape-confirmation button 35 causes a non-coincident-portion confirmation function of the non-coincident portion extracting section 12 to confirm whether or not at least a part of the non-coincident portion is to remain and the modification has generated another non-coincident portion.

In the example shown in FIG. 7, an element C is assigned as a control element on the assignation box 31; an element D is assigned as a target element to be modified on the assignation box 32; a Y direction (+) is assigned as a modification direction in which the element D is to be modified on the setting field 33.

Direct input of the numbers of the rectangular parallelepipeds (cuboid No.) in the assigning boxes 31 and 32 assigns a rectangular parallelepiped to be modified in shape in a unit of a rectangular parallelepiped.

The analysis data retaining section 14 retains analysis data generated by the analysis data generating section 11 and retains analysis data in which non-coincident portions are dissolved by the adjusting section 13.

The analyzing section 15 analyzes (simulates) the object using the analysis data in which non-coincident portions are dissolved by the adjusting section 13 in order to understand, for example, stress and deformation on the object. An analysis carried out by the analyzing section 15 can be any method as long as analysis data generated by the analysis data generating section 11 is used, and the present invention should by no means limit the method.

The display controlling section 17 controls contents to be displayed on the monitor 16. In the illustrated example, the display controlling section 17 displays, on the monitor 16, 3D design data retained in the 3D design data retaining section 10; analysis data retained in the analysis data retaining section 14; emphasizes a non-coincident portion extracted by the non-coincident portion extracting section 12 on the analysis data; and displays a setting determining screen (see FIG. 7) of the setting determining section 13a.

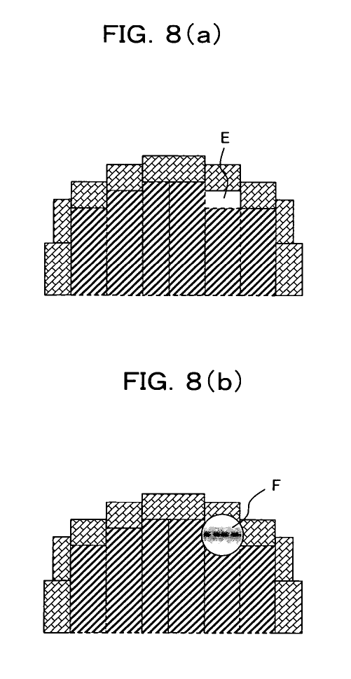

FIGS. 8(a) and 8(b) illustrate an example of emphasis of a non-coincident portion by the display controlling section 17. As shown in FIG. 8(a), when the non-coincident portion extracting section 12 extracts a non-coincident portion E from analysis data generated by the analysis data generating section 11, the display controlling section 17 as shown in FIG. 8(b), puts a balloon F on the non-coincident portion E to emphasize the non-coincident portion E. In such an emphasis display, the operator can confirm the non-coincident portion E with ease. The operator clicks the balloon F and the setting determining screen 30 exemplified by FIG. 7 is displayed on the monitor 16.

The present invention should by no means limit an emphasis display for a non-coincident portion by the display controlling section 17 to the example shown in FIG. 8(b). Alternatively, the balloon F may be set to appear over or under the non-coincident portion E, or further, the non-coincident portion is emphasized by a line or color different from the remaining portion without using the balloon F. Any emphasizing manner can be applied whenever the non-coincident portion E is more emphasized than the remaining portion.

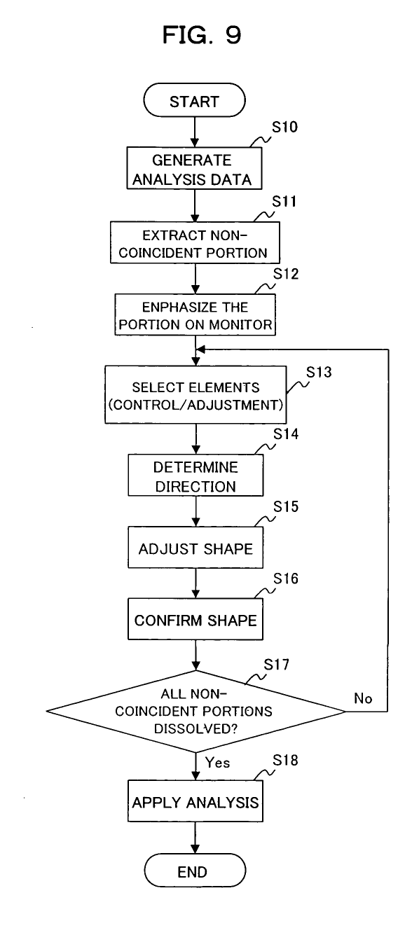

Next, with reference to flow diagram FIG. 9, a succession of procedural steps (steps S10-S18) will now be described. The procedural steps S10-S17 in FIG. 9 include a method for generating analysis data of the present invention.

First of all, as shown in FIG. 9, the analysis data generating section 11 generates analysis data of an object formed by a number of elements by dividing 3D design data representing the object, which design data is retained in the 3D design data retaining section 10, into a plurality of rectangular parallelepipeds for each element (step S10; analysis data generating step).

Subsequently, the non-coincident portion extracting section 12 extracts, from the generated analysis data, non-coincident portions formed by surfaces of two of the rectangular parallelepipeds included in the analysis data which surfaces do not coincide with each other and corresponds to surfaces of two elements coinciding with each other in the 3D design data on the basis of position data of the rectangular parallelepipeds (step s11; non-coincident portion extracting step).

Here, assuming that the above step S10 generates analysis data including rectangular parallelepipeds J1-J3 and K1-K3 shown in FIG. 10(a), the non-coincident portion extracting section 12 compares the generated analysis data with the 3D design data and confirms whether or not data of positions of surfaces (boundaries) of two rectangular parallelepipeds, corresponding one to each of surfaces of two elements coincide with each other in the 3D design data, coincide with each other. In this example, on the basis of the position data shown in FIG. 10(b), the non-coincident portion extracting section 12 confirms whether or not Y-High surfaces of the rectangular parallelepipeds J1, J2 and J3 coincide with Y-Low surfaces of the rectangular parallelepipeds K1, K2 and K3, respectively. Namely, as shown in FIG. 10(c), if the surfaces coincide with each other, a line (in the form of a surface in three dimensions; FIG. 10(a) is simplified in two dimensions) appears. On the contrary, the surfaces not coinciding with each other result in the appearance of two lines (two surfaces) and the non-coincident portion extracting section 12 extracts a non-coincident portion K′ from the analysis data.

Then the display controlling section 17 emphasizes the non-coincident portion K′ extracted by the non-coincident portion extracting section 12 by putting on a balloon F as shown in FIG. 10(d) (step S12, emphatically displaying step).

The setting determining section 13a selects one of two rectangular parallelepipeds that form the non-coincident portion as a control and assigns the other rectangular parallelepiped as a target rectangular parallelepiped that is to be modified in shape in order to dissolve the non-coincident portion (step S13).

After the setting determining section 13a assigns a direction in which the target rectangular parallelepiped is to be modified (step S14), the adjusting section 13 carries out modification of the shape of the target rectangular parallelepiped on the basis of the setting determined by the setting determining section 13a (step S15, adjusting step).

The function for non-coincident-portion confirmation of the non-coincident portion extracting section 12 confirms whether or not at least part of the non-coincident portion remains in the analysis data in which the non-coincident portions have been dissolved by the adjusting section 13 and concurrently the modification generates no additional non-coincident portion (step S16, non-coincident-portion confirming step). If the result of the confirmation is negative (i.e., the entire non-coincident portions have been dissolved; no route in step S17), the above steps S13-S16 are repeatedly performed until the confirmation function determines that the entire non-coincident portions have been dissolved (yes route in step S17). After that, the analyzing section 15 applies an analysis to the object using the analysis data (step S18, analyzing step) and the succession of the procedural steps is completed.

According to the analysis apparatus 1 and the analysis method of the first embodiment of the present invention, it is possible to efficiently generate analysis data that is to be used for analysis applied to an object formed by a number of elements because a non-coincident portion (such as gaps) in the generated analysis data is automatically dissolved without an operation by the operator.

Since the adjusting section 13 modifies the shape of a rectangular parallelepiped based on the settings determined by the operator on the setting determining section 13a, it is possible to prevent an additional non-coincident portion from being generated at a position different from the non-coincident portion that is about to be dissolved whereby it is possible to definitely and rapidly dissolve non-coincident portions.

The setting determining section 13a determines a control rectangular parallelepiped serving as a control to fix the position and the shape and a target rectangular parallelepiped the shapes of which are to be modified, and only one of two rectangular parallelepipeds that form a non-coincident portion is modified in shape, so that it is possible to prevent another non-coincident portion from being generated at a position different from the non-coincident portion that is about to be dissolved whereby it is possible to definitely and rapidly dissolve non-coincident portions.

Further, since the non-coincident-portion confirmation function of the non-coincident portion detecting means 12 confirms whether or not at least part of the non-coincident portion remains in the analysis data in which the non-coincident portion has been dissolved by the adjusting section 13 and concurrently whether or not the modification has generated no additional non-coincident portion, analysis data can be efficiently generated requiring no operator's manual operation for confirmation of remaining non-coincident portions and it is possible to definitely generate analysis data in which non-coincident portions are completely deleted.

### (2) Others

Further, the present invention should by no means be limited to this foregoing embodiment, and various changes or modifications may be suggested without departing from the gist of the invention.

For example, in the first embodiment, 3D design data generated by means of CAD or the like is converted into analysis data. The present invention however should by no means be limited to this. Alternatively, the analysis data may be generated on the basis of design data in two dimensions.

In the illustrated embodiment, a non-coincident portion is formed by a pair of rectangular parallelepipeds. Analysis data generated by the analysis data generating section 11 may have a non-coincident portion formed by three or more rectangular parallelepipeds. In the present invention, the non-coincident portion extracting section 12 compares analysis data with 3D design data whereby a non-coincident portion formed by surfaces of rectangular parallelepipeds which surfaces do not coincide with each other and are corresponding to the surfaces of two elements that coincide with each other in the 3D design data whereby it is possible to apply the present invention to a non-coincident portion formed by three or more rectangular parallelepipeds.

Further, in order to prevent a single non-coincident portion from being formed by three or more rectangular parallelepipeds, the analysis data generating section 11 of the present invention may generate analysis data in such a manner that a single non-coincident portion is always formed by two rectangular parallelepipeds. For example in this case, the analysis data generating section 11 may provisionally generate analysis data and regenerate the analysis data keeping the number of rectangular parallelepipeds representing each element by changing each rectangular parallelepiped in size such that a single non-coincident portion is formed by a pair of rectangular parallelepipeds. The number of rectangular parallelepipeds representing each element may be changed if the change interferes with the accuracy required for analysis.

Further, in the above-mentioned first embodiment, the non-coincident portion detecting means 12 compares analysis data with the 3D design data and extracts a non-coincident portion from the analysis data. But the present invention should by no means be limited to the above manner.

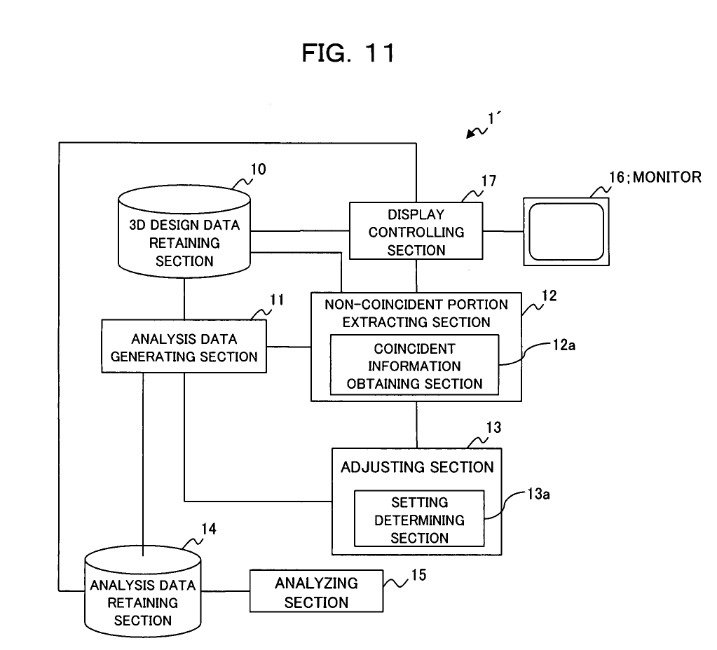

Here, FIG. 11 is a block diagram schematically showing an analysis apparatus 1′ serving as a modification of the first embodiment. For example, as shown in FIG. 11, the non-coincident portion detecting means 12 includes a coincident information obtaining section 12a which obtains, as information about relationship between 3D design data and analysis data, coincident information concerning two rectangular parallelepipeds corresponding to a part of a connection at which two elements coincide with each other in the 3D design data and a direction of coincidence. On the basis of the coincident information obtained by the coincident information obtaining section 12a, a non-coincident portion may be extracted from analysis data.

Here, coincident information obtained by the coincident information obtaining section 12a, for example, includes identification numbers (cuboid numbers) of a pair or rectangular parallelepipeds and the coincidence direction.

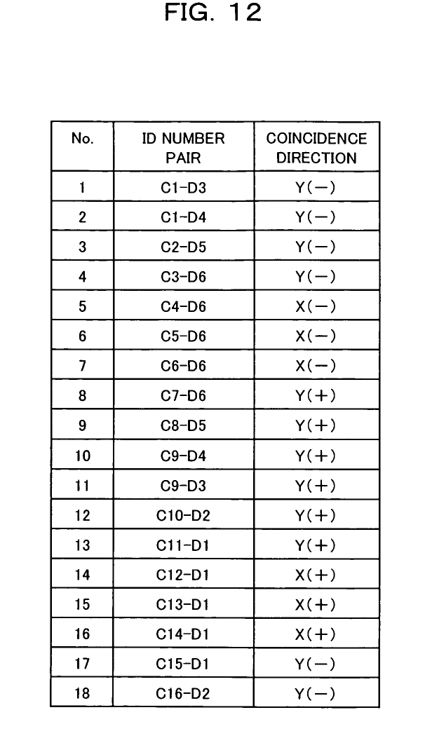

Namely, when the analysis data generating section 11 divides the 3D design data into a number of rectangular parallelepipeds, the coincident information obtaining section 12a obtains coincident information which indicates that two rectangular parallelepipeds, corresponding one to each of two elements that coincide with each other in the 3D design data, establish coincidence relationship. For example, concerning an object shown in FIGS. 2(a) and 2(b), the non-coincident portion extracting section 12a obtains, as coincident information, a pair of cuboid numbers C1 and D3 and Y-axis negative (−) direction in which the two rectangular parallelepipeds C1 and D3 coincide with each other; a pair of cuboid numbers C1 and D4 and Y-axis negative (−) direction in which the two rectangular parallelepipeds C1 and D4 coincide with each other; and a pair of cuboid numbers C2 and D5 and Y-axis negative (−) direction in which the two rectangular parallelepipeds C2 and D5 coincide with each other, as shown in FIG. 12. In the same manner, the non-coincident portion extracting section 12a obtains coincident information of all the rectangular parallelepipeds as shown in FIG. 12.

After that, the non-coincident portion extracting section 12 may extract a pair or rectangular parallelepipeds having surfaces which do not coincide with each other on the basis of the position data (see FIG. 3) of each rectangular parallelepiped included in the analysis data and the coincident information (see FIG. 12) obtained by the non-coincident portion extracting section 12a, so that a non-coincident portion is extracted from the analysis data.

In this modification, for example, on the basis of coincident information which indicates that rectangular parallelepipeds C2 and D5 coincide with each other in a direction of negative Y axis of the rectangular parallelepiped C2 shown in FIG. 12, the non-coincident portion extracting section 12 compares Y-Low coordinate of the rectangular parallelepiped C2 with Y-High coordinate of the rectangular parallelepiped D5 from position data concerning each of the surfaces of the rectangular parallelepipeds C2 and D5 shown in FIG. 3. Here, the two coordinates do not coincide with each other and the non-coincident portion extracting section 12 therefore extracts an empty space (a white space) between the rectangular parallelepipeds C2 and D5 as shown in FIG. 2(b) as a non-coincident portion E1. On the other hand, since Y-Low coordinate of the rectangular parallelepiped C1 coincides with Y-High coordinate of the rectangular parallelepiped D4, the non-coincident portion extracting section 12 extracts no non-coincident portion between these two rectangular parallelepipeds.

As mentioned above, according to the analysis apparatus 1′ according to the modification, the non-coincident portion extracting section 12 extracts a non-coincident portion based on position data of rectangular parallelepipeds and coincident information obtained by the non-coincident portion extracting section 12a, and consequently obtains advantageous results as the previous first embodiment.

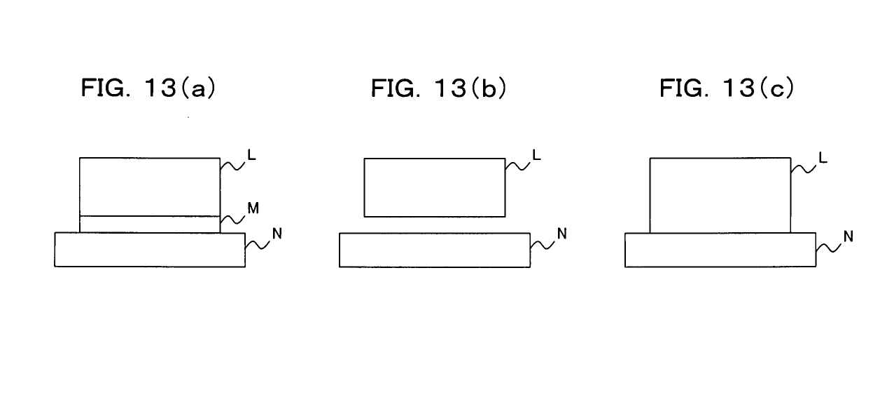

The non-coincident portion extracting section 12, the adjusting section 13 and the setting determining section 13a in analysis apparatuses 1 and 1′ of the present invention can apply to an object being at the designing stage by means of CAD beside generation of analysis data as described above. In other words, in CAD data representing an assembly formed by three elements L, M and N as shown in FIG. 13(a), if the element M can be replaced by element L, the elements M may be removed as shown in FIG. 13(b). At that time, the non-coincident portion extracting section 12 (the non-coincident portion extracting section 12a) of the present invention extracts the gap between the elements L and M from the CAD data, and the adjusting section 13 and the setting determining section 13a of the present invention modifies the element L in shape in agreement with the shape of the extracted gap as shown in FIG. 13(c), so that the gap can be dissolved.

The functions of the analysis data generating section 11, the non-coincident portion extracting section 12, the non-coincident portion extracting section 12a, the adjusting section 13, the setting determining section 13a, the analyzing section 15, and the display controlling section 17 may be realized by a computer (including a CPU, an information terminal, and/or various terminals) executing a certain program (an analysis program or an analysis data generating program).

Such programs are provided in the form stored in a computer-readable recoding medium exemplified by a flexible disk, a CD (CD-ROM, CD-R, CD-RW or the like), a DVD (DVD-ROM, DVD-RAM, DVD-R, DVD-RW, DVD+R, DVD+RW, or the like). In this case, a computer reads the analysis program or the analysis data generating program from a recording medium and sends the read program to an internal or external memory to store the program for use. Alternatively, such a program is recorded in a memory (a recording medium) such as a magnetic disk, an optical disk or a magneto-optical disk and is provided to a computer from the memory through a communication line.

The concept of a computer here includes hardware and an OS (Operating System) and means hardware that operates under control of the OS. If an application program independently operates hardware, requiring no OS, the hardware itself corresponds to a computer. Hardware includes at least a microprocessor such as a CPU and means for reading a computer program stored in a recording medium.

An application program serving as the above analysis program includes a program code which instructs a computer of a kind described above to function as the analysis data generating section 11, the non-coincident portion extracting section 12, the non-coincident portion extracting section 12a, the adjusting section 13, the setting determining section 13a, the analyzing section 15, and the display controlling section 17. The part of the function may be realized by an OS, not by the application program.

Further, an application program serving as the above analysis data generating program includes a program code which instructs a computer of a kind described above to function as the analysis data generating section 11, the non-coincident portion extracting section 12, the non-coincident portion extracting section 12a, the adjusting section 13, the setting determining section 13a, and the display controlling section 17. The part of the function may be realized by an OS, not by the application program.

The recording medium used in the present invention may be one from various computer-readable recording mediums in the form of an IC card, a ROM cartridge, a magnetic tape, a punch card, an internal memory (such as a RAM or a ROM) in a computer, an external memory, or a printed matter on which codes such as bar codes are printed, other than the above examples of a flexible disk, a CD, a DVD, a magnetic disk, an optical disk or a magneto-optical disk.

What is claimed is:

1. An apparatus for generating analysis data comprising:
an analysis data generating section for generating analysis data by dividing three-dimensional design data representing an object formed by a plurality of elements into a number of rectangular parallelepipeds for each of the plural elements;
a non-coincident portion extracting section for extracting, from the analysis data, a possible non-coincident portion formed by surfaces of two of the rectangular parallelepipeds included in said analysis data generated by said analysis data generating section, the surfaces not coinciding with each other, the two rectangular parallelepipeds being corresponding one to each of two of the plural elements surfaces of which coincide with each other in the three-dimensional design data; and
an adjusting section for adjusting a shape of at least one of the two rectangular parallelepipeds, which form said possible non-coincident portion extracted by said non-coincident portion extracting section, in such a manner that said possible non-coincident portion is dissolved, so that the analysis data is corrected.

2. An apparatus for generating analysis data according to claim 1, wherein said non-coincident portion extracting section extracts said possible non-coincident portion on the basis of position data concerning positions of the surface of the two rectangular parallelepipeds which surfaces are corresponding to the surfaces of the two elements that coincide with each other in the three-dimensional design data, which position data is included in the analysis data.

3. An apparatus for generating analysis data according to claim 1, said apparatus further comprising a coincident information obtaining section for obtaining coincident information concerning the two rectangular parallelepipeds corresponding to a part of a connection at which the two elements coincide with each other in the three-dimensional design data and a direction of coincidence of the two elements,
wherein said non-coincident portion extracting section for extracting said possible non-coincident portion based on the coincident information obtained by said coincident information obtaining section.

4. An apparatus for generating analysis data according to claim 1, wherein said adjusting section adjusts the shapes of one or more of the rectangular parallelepipeds, corresponding to an identical one of the two elements the surfaces of which coincide with each other and which form the plurality of said possible non-coincident portions.

5. An apparatus for generating analysis data according to claim 1, wherein said adjusting section adjusts the shape of the at least one rectangular parallelepiped in a direction perpendicular to one of surfaces of the at least one rectangular parallelepiped.

6. An apparatus for generating analysis data according to claim 1, further comprising a setting determining section for determining the at least one rectangular parallelepiped that is to be adjusted and a direction in which the at least one rectangular parallelepiped is adjusted.

7. An apparatus for generating analysis data according to claim 1, further comprising a display controlling section for emphasizing said possible non-coincident portion extracted by said non-coincident portion extracting section on a monitor displaying the analysis data.

8. An apparatus for generating analysis data according to claim 1, said non-coincide portion extracting section confirms whether or not at least a part of said possible non-coincident portion is remaining in the analysis data in which the at least one rectangular parallelepiped has been adjusted.

9. A computer-readable recording medium in which a program for generating analysis data that is to be used for application of analysis to an object formed by a plurality of elements is recorded, wherein said program instructs a computer to function as:
an analysis data generating section for generating analysis data by dividing three-dimensional design data representing the object into a number of rectangular parallelepipeds for each of the plural elements;
a non-coincident portion extracting section for extracting, from the analysis data, a possible non-coincident portion formed by surfaces of two of the rectangular parallelepipeds included in said analysis data generated by said analysis data generating section, the surfaces not coinciding with each other, the two rectangular parallelepipeds being corresponding one to each of two of the plural elements surfaces of which coincide with each other in the three-dimensional design data; and
an adjusting section for adjusting a shape of at least one of the two rectangular parallelepipeds, which form said possible non-coincident e portion extracted by said non-coincident portion extracting section, in such a manner that said possible non-coincident portion is dissolved, so that the analysis data is corrected.

10. A computer-readable recording medium according to claim 9, wherein said program instructs the computer to cause said non-coincident portion extracting section to extract said possible non-coincident portion on the basis of position data concerning positions of the surfaces of the two rectangular parallelepipeds which surfaces are corresponding to the surfaces of the two elements that coincide with each other in the three-dimensional design data, which position data is included in the analysis data.

11. A computer-readable recording medium according to claim 9, wherein said program instructs the computer to:
function as a coincident information obtaining section for obtaining coincident information concerning the two rectangular parallelepipeds corresponding to a part of a connection at which the two elements coincide with each other in the three-dimensional design data and a direction of coincidence of the two elements; and
cause said non-coincident portion extracting section for extracting said possible non-coincident portion based on the coincident information obtained by said coincident information obtaining section.

12. A computer-readable recording medium according to claim 9, wherein said program instructs the computer to cause said adjusting section to adjust the shapes of one or more of the rectangular parallelepipeds, corresponding to an identical one of the two elements the surfaces of which coincide with each other and which form the plurality of said possible non-coincident portions.

13. A computer-readable recording medium according to claim 9, wherein said program instructs the computer to cause said adjusting section to adjust the shape of the at least one rectangular parallelepiped in a direction perpendicular to one of the surfaces of the at least one rectangular parallelepiped.

14. A computer-readable recording medium according to claim 9, wherein said program further instructs the computer to function as a setting determining section for determining the at least one rectangular parallelepiped that is to be adjusted and a direction in which the at least one rectangular parallelepiped is adjusted.

15. computer-readable recording medium according to claim 9, wherein said program further instructs the computer to function as a display controlling section for emphasizing said possible non-coincident portion extracted by said non-coincident portion extracting section on a monitor displaying the analysis data.

16. computer-readable recording medium according to claim 9, wherein said program further instructs the computer to cause as said non-coincident portion extracting section to confirm whether or not at least a part of said possible non-coincident portion is remaining in the analysis data in which the at least one rectangular parallelepiped has been adjusted.

17. A method for generating analysis data comprising the steps of:
(a) generating analysis data by dividing three-dimensional design data representing an object formed by a plurality of elements which design data is retained in a memory into a number of rectangular parallelepipeds for each of the plural elements;
(b) extracting, from the analysis data, a possible non-coincident portion formed by surfaces of two of the rectangular parallelepipeds included in said analysis data generated in said step (a) of generating, the surfaces not coinciding with each other, the two rectangular parallelepipeds being corresponding one to each of two of the plural elements surfaces of which coincide with each other in the three-dimensional design data; and
(c) adjusting a shape of at least one of the two rectangular parallelepipeds, which form said possible non-coincident portion extracted in said step (b) of extracting, in such a manner that said possible non-coincident portion is dissolved, so that the analysis data is corrected.

18. An analysis apparatus comprising:
an analysis data generating section for generating analysis data by dividing three-dimensional design data representing an object formed by a plurality of elements into a number of rectangular parallelepipeds for each of the plural elements;
a non-coincident portion extracting section for extracting, from the analysis data, a possible non-coincident portion formed by surfaces of two of the rectangular parallelepipeds included in said analysis data generated by said analysis data generating section, the surfaces not coinciding with each other, the two rectangular parallelepipeds being corresponding one to each of two of the plural elements surfaces of which coincide with each other in the three-dimensional design data;
an adjusting section for adjusting a shape of at least one of the two rectangular parallelepipeds, which form said possible non-coincident portion extracted by said non-coincident portion extracting section, in such a manner that said possible non-coincident portion is dissolved, so that said analysis data is corrected; and
an analyzing section for applying the object to analysis using said analysis data corrected by said adjusting section.

19. A computer-readable recording medium in which a program for generating analysis data that is to be used for application of analysis to an object formed by a plurality of elements and applying the analysis to the object using the analysis data is recorded, wherein said program instructs a computer to function as:
an analysis data generating section for generating analysis data by dividing three-dimensional design data representing the object into a number of rectangular parallelepipeds for each of the plural elements;
a non-coincident portion extracting section for extracting, from analysis data, a possible non-coincident portion formed by surfaces of two of the rectangular parallelepipeds included in said analysis data generated by said analysis data generating section, the surfaces not coinciding with each other, the two rectangular parallelepipeds being corresponding one to each of two of the plural elements surfaces of which coincide with each other in the three-dimensional design data;
an adjusting section for adjusting a shape of at least one of the two rectangular parallelepipeds, which form said possible non-coincident portion extracted by said non-coincident portion extracting section, in such a manner that said possible non-coincident portion is dissolved, so that said analysis data is corrected; and
an analyzing section for applying the object to analysis using said analysis data corrected by said adjusting section.

20. An analyzing method comprising the steps of:
(a) generating analysis data by dividing three-dimensional design data representing an object formed by a plurality of elements which design data is retained in a memory into a number of rectangular parallelepipeds for each of the plural elements;
(b) extracting, from the analysis data, a possible non-coincident portion formed by surfaces of two of the rectangular parallelepipeds included in said analysis data generated in said step (a) of generating, the surfaces not coinciding with each other, the two rectangular parallelepipeds being corresponding one to each of two of the plural elements surfaces of which coincide with each other in the three-dimensional design data; and
(c) adjusting a shape of at least one of the two rectangular parallelepipeds, which form said possible non-coincident portion extracted in said step (n) of extracting, in such a manner that said possible non-coincident portion is dissolved, so that the analysis data is corrected; and
(d) applying the object to analysis using said analysis data corrected in said step (c) of adjusting.
